(19) United States
(12) Patent Application Publication
(10) Pub. No.: US 2018/0105438 A1
(43) Pub. Date: Apr. 19, 2018

(54) ULTRAVIOLET DEVICES AND METHODS FOR THE INACTIVATION OF A PATHOGEN IN A FLOWING WATER SAMPLE

(71) Applicant: The Board of Trustees of the University of Alabama, Tuscaloosa, AL (US)

(72) Inventors: Mark Elliott, Tuscaloosa, AL (US); Patrick Kung, Tuscaloosa, AL (US); Benjamin Bickerstaff, Tuscaloosa, AL (US)

(21) Appl. No.: 15/783,190

(22) Filed: Oct. 13, 2017

Related U.S. Application Data
(60) Provisional application No. 62/408,274, filed on Oct. 14, 2016.

(51) Int. Cl. C02F 1/32; G02B 19/00

(52) U.S. Cl. CPC C02F 1/325; G02B 19/0019; G02B 19/0095; C02F 2201/3225; C02F 2201/3228; C02F 2201/3222; C02F 2201/3226; C02F 2303/04

(57) ABSTRACT

The present disclosure relates to devices and methods for the disinfection of a flowing water sample using ultraviolet light.

### CROSS REFERENCE TO RELATED APPLICATIONS

This application claims the benefit of U.S. Provisional Patent Application Ser. No. 62/408,274 filed Oct. 14, 2016, the disclosure of which is expressly incorporated herein by reference.

### FIELD

The present disclosure relates to devices and methods for the disinfection of a flowing water sample using ultraviolet light.

### BACKGROUND

Previous drinking water disinfection methods that protect users from pathogens have one or more of the following disadvantages: (1) they create unpleasant tastes and odors, (2) generate harmful disinfection by-products, (3) are incompatible with in-home use, (4) are expensive, and (5) are large and/or difficult to install and maintain. There is a need for a simple, compact, inexpensive, drinking water disinfection unit that can be easily installed on a faucet or water bottle and protects users from pathogens. This need exists both in the United States and in many settings around the world.

One example of a water filtering product includes the Brita products. However, there are several problems associated with this technology. First, these require frequent and expensive filter changes. Importantly, these filters do not provide disinfection of the water. Second, Brita products are useful for batches, but are not useful for continuous or flowing water samples. Another example of a water filtering product includes the SteriPEN. While this product can disinfect water, it is only useful for small batches and thus cannot be used for flowing water samples. In addition, these drinking water disinfection methods still leave unpleasant tastes and odors, generate harmful disinfection by-products, are incompatible with in-home flow-through use, and are large and/or difficult to install and maintain.

The devices and methods disclosed herein address these and other needs.

### SUMMARY

Disclosed herein is a compact flow-through device that can be used for the disinfection of a flowing water sample using ultraviolet light. The ultraviolet (UV) lamp is in direct contact, or in close contact, with the flowing water sample and the UV lamp is enclosed in a highly reflective cavity, allowing higher flow rates and minimizing the optical losses. In addition, the devices disclosed herein deliver the ultraviolet light radially both inward and outward, which allows the outward rays to already participate in water disinfection even before they are reflected by the highly reflective cavity (i.e. an aluminum surface). The devices disclosed herein are useful in methods for the disinfection of water, and are useful for the inactivation of pathogens in flowing water samples.

In one aspect, provided herein is a device for the inactivation of a pathogen in a flowing water sample, the device comprising:
a housing container, wherein the housing container comprises a highly reflective cavity;
an ultraviolet lamp, wherein the ultraviolet lamp is comprised within the housing container;
an entry point and exit point for a flowing water sample, wherein the flowing water sample is in direct contact or in close contact with the ultraviolet lamp; and
wherein the ultraviolet lamp delivers ultraviolet light rays both radially inward and outward.

In another aspect, provided herein is a method for inactivating a pathogen in a flowing water sample, comprising:
subjecting a flowing water sample to a device, the device comprising:
   a housing container, wherein the housing container comprises a highly reflective cavity;
   an ultraviolet lamp, wherein the ultraviolet lamp is comprised within the housing container;
   an entry point and exit point for a flowing water sample, wherein the flowing water sample is in direct contact or in close contact with the ultraviolet lamp; and
wherein the ultraviolet lamp delivers ultraviolet light rays both radially inward and outward for inactivating a pathogen.

In one embodiment, the device further comprises a flow sensor, wherein the flow sensor indicates the amount of an ultraviolet light dose provided to the flowing water sample. In one embodiment, the device further comprises a highly reflective material lining the housing container. In one embodiment, the device further comprises a protective coating over the highly reflective material.

In one embodiment, the ultraviolet lamp is a low pressure, medium pressure, or high-pressure mercury lamp. In one embodiment, the ultraviolet lamp is a cold cathode lamp. In one embodiment, the ultraviolet lamp is a UV LED. In one embodiment, the ultraviolet lamp is a UV laser light source.

In one embodiment, the flow sensor is a digital representation. In one embodiment, the flow sensor is a liquid-crystal display (LCD) (LCD) display. In one embodiment, the flow sensor is a light emitting diode (LED) bar indicator. In one embodiment, the flow sensor is a dial. In one embodiment, the flow sensor is a visible light.

In one embodiment, the method kills greater than 99% of a pathogen in the flowing water sample. In one embodiment, the method kills greater than 99.9% of a pathogen in the flowing water sample. In one embodiment, the method kills greater than 99.99% of a pathogen in the flowing water sample.

### BRIEF DESCRIPTION OF THE DRAWINGS

The accompanying figures, which are incorporated in and constitute a part of this specification, illustrate several aspects described below.

FIG. 1 shows a cross-sectional diagram illustrating an example of a UV-lamp device for the disinfection of a flowing water sample. FIG. 1 is further described in Example 1.

FIG. 2 shows an illustration of the type of 3D optical simulations of a UV lamp water reactor. FIG. 2 is further described in Example 3.

FIG. 3 shows a schematic of an example of a spiral UV lamp device for the disinfection of a flowing water sample. The UV lamp is shown split into two, where the smaller spiral is dimensioned so as to fit into the larger spiral.

FIG. 4 shows a schematic of an example of a spiral UV lamp device for the disinfection of a flowing water sample, where the smaller spiral is shown to fit into the larger spiral.

### DETAILED DESCRIPTION

Disclosed herein is a compact flow-through device that can be used for the disinfection of a flowing water sample using ultraviolet light. The ultraviolet (UV) lamp is in direct contact, or in close contact, with the flowing water sample and the UV lamp is enclosed in a highly reflective cavity, allowing higher flow rates and minimizing the optical losses. In addition, the devices disclosed herein deliver the ultraviolet light radially both inward and outward, which allows the outward rays to already participate in water disinfection even before they are reflected by the highly reflective cavity (i.e. an aluminum surface). The devices disclosed herein are useful in methods for the disinfection of water, and are useful for the inactivation of pathogens in flowing water samples.

Previous drinking water disinfection methods leave unpleasant tastes and odors, generate harmful disinfection by-products, are incompatible with in-home flow-through use, are expensive, or are large and/or difficult to install and maintain. Disclosed herein is a compact and inexpensive flow-through device that can be used for the disinfection of a water sample using ultraviolet light.

Reference will now be made in detail to the embodiments of the invention, examples of which are illustrated in the drawings and the examples. This invention may, however, be embodied in many different forms and should not be construed as limited to the embodiments set forth herein.

Unless defined otherwise, all technical and scientific terms used herein have the same meaning as commonly understood to one of ordinary skill in the art to which this invention belongs.

The technology herein possesses a new optical configuration that enables residential point-of-use/point-of-entry drinking water treatment that (1) provides an economical option to treat water at the household level over centralized drinking water systems, (2) at market attractive flow rates, and (3) that meet EPA drinking water standards, none of which are achieved by current product offerings.

A UV disinfection treatment device that is affordable, chemical-free, pathogen-free in a user-friendly form factor will benefit people by protecting them from waterborne disease and from the disinfection by-products generated by chemical disinfectants. This in turn reduces exposure to pathogens in the environment therefore impacting people and prosperity.

UV disinfection precludes the use of chlorine for wastewater treatment, and the discharge of chlorine and its by-products to waterways are covered under the Clean Water Act. Drinking water treatment protects human health and is covered under the Safe Drinking Water Act. Due to their known and potential health effects, the EPA regulates the presence of disinfection byproducts (DBPs) in drinking water under the Stage 1 and Stage 2 Disinfection/Disinfection Byproducts Rules implemented in 2001 and 2006, respectively. The disinfection byproducts of note include, for example, the four trihalomethanes (THMs): trichloromethane (or chloroform), bromodichloromethane, dibromochloromethane, and tribromomethane (or bromoform). The EPA regulates trihalomethanes because prolonged consumption above the maximum contaminant level of 0.08 mg/L can cause various cancers.

### Water Treatment

America's water distribution systems are overtaxed and in severe need of repair. Many of the metal pipes that comprise these systems have exceeded their useful life; many have been in use for over a century, with some even predating the Civil War. Over time the pipes have become brittle and begun to easily break. In fact, according to the EPA, there are 240,000 water main breakages per year. Unfortunately, fixing this problem with renovations isn't as simple as just digging up and replacing the pipes. With over 1 million miles of pipes currently in place, the replacement process will be lengthy and expensive. In addition to those using public piped water, more than 30 million Americans still use untreated well water as their primary water source. Also, many communities in developing countries cannot provide safe drinking water to the home. For example, in India and China, hundreds of millions of people have gained access to piped water since 1990, but the water is typically unsafe to drink (WHO and UNICEF (2015). Progress on Sanitation and Drinking Water: 2015 Update and MDG Assessment. Geneva: World Health Organization; Kumpel, E., & Nelson, K. L. (2014). Environmental science & technology, 48(5), 2766:2775). Additionally, unsafe sanitation, including nearly 900 million people defecating in the open (WHO and UNICEF, 2015), can contaminate the ground and lead to the widespread contamination of water sources and occurrence of waterborne diseases.

Disclosed herein is a UV lamp containing device that can provide consumers with microbiologically safe drinking water through an efficient point of use (POU) device. In comparison, activated carbon filters, such as in Pur and Brita filters, which are very common amongst consumers, do not remove harmful microbiological pathogens (viruses and bacteria), such as E. coli.

In the United States, waterborne disease is still a major threat to the elderly, immuno-compromised, the very young, and those with gastrointestinal diseases (e.g., Crohn's disease). The EPA and CDC estimate contaminated public water systems account for 13 million annual cases of water borne illnesses in the US. These cases result in 240,000 hospitalizations per year with annual costs of $937 million. Water treatment and reuse using instant-on/off capable UV lamps with intensity sensors (flow sensors) has many advantages over other disinfection methods, including, for example: energy efficiency, lightness and portability, no formation of disinfection byproducts, low heat generation, and the potential for very low cost.

The previous continuous flow devices available are very expensive and aimed at commercial use rather than in home use. These products are not economically viable for the residential consumer market. More consumer-friendly UV systems are expensive and utilize what is known as “batch” treatment. Batch treatment must first collect the water in a container, such as a pitcher or bottle, and then shine the UV treatment on the whole batch. These products process very little water, have high upfront costs, and are not convenient for residential consumer use.

### Device and Methods

Disclosed herein is a compact flow-through device that can be used for the disinfection of a water sample using ultraviolet light.

In one aspect, provided herein is a device for inactivation of a pathogen in a flowing water sample, the device comprising:
a housing container, wherein the housing container comprises a highly reflective cavity;
an ultraviolet lamp, wherein the ultraviolet lamp is comprised within the housing container;
an entry point and exit point for a flowing water sample, wherein the flowing water sample is in direct contact or in close contact with the ultraviolet lamp; and
wherein the ultraviolet lamp delivers ultraviolet light rays both radially inward and outward.

In another aspect, provided herein is a method for inactivating a pathogen in a flowing water sample, comprising:
subjecting a flowing water sample to a device, the device comprising:
   a housing container, wherein the housing container comprises a highly reflective cavity;
   an ultraviolet lamp, wherein the ultraviolet lamp is comprised within the housing container;
   an entry point and exit point for a flowing water sample, wherein the flowing water sample is in direct contact or in close contact with the ultraviolet lamp; and
wherein the ultraviolet lamp delivers ultraviolet light rays both radially inward and outward for inactivating a pathogen.

In one embodiment, the device further comprises a flow sensor, wherein the flow sensor indicates the amount of an ultraviolet light dose provided to the flowing water sample. In one embodiment, the device further comprises a highly reflective material lining the housing container. In one embodiment, the device further comprises a protective coating over the highly reflective material.

In one embodiment, the ultraviolet lamp is a low pressure, medium pressure, or high-pressure mercury lamp. In one embodiment, the ultraviolet lamp is a cold cathode lamp. In one embodiment, the ultraviolet lamp is a UV LED. In one embodiment, the ultraviolet lamp is a UV laser light source.

In one embodiment, the flow sensor is a visible light. In one embodiment, the flow sensor is a digital representation. In one embodiment, the flow sensor is an LCD display. In one embodiment, the flow sensor is a dial.

In one embodiment, the method kills greater than 99% of pathogens in the flowing water sample. In one embodiment, the method kills greater than 99.9% of pathogens in the flowing water sample. In one embodiment, the method kills greater than 99.99% of pathogens in the flowing water sample.

In one embodiment, the flowing water sample is in direct contact with the ultraviolet lamp. In one embodiment, the flowing water sample is in close contact with the ultraviolet lamp.

In some embodiments, the device disclosed herein can treat 5 liters per minute (1.32 gallons per minute) at a dose of 80 mJ/cm² and achieves 99.99% (4-log) inactivation of MS2 virus as it flows out from the water-dispensing source. The National Sanitation Foundation International (NSF International) required dose for its most stringent (Class A) POU UV treatment standard is 40 mJ/cm²; the present device can achieve twice this dose.

In some embodiments the water flow rate is about from about 2 L/min to about 10 L/min). In one embodiment, the water flow rate is about 2 L/min. In one embodiment, the water flow rate is about 5 L/min. In one embodiment, the water flow rate is about 10 L/min.

This device can be used, for example, on a household water-faucet. This device can also be used, for example, to disinfect water flowing into a liquid container (for example, water bottle). The device can be used alone or in conjunction with in-line carbon filtration. In some embodiments, the device can achieve at least 4-log₁₀ (99.99%) reduction of MS2. In some embodiments, the flow rate of the water is up to 5 L/min.

In some embodiments, the flowing water sample is passed through one UV lamp containing device as disclosed herein. In some embodiments, the flowing water sample is passed through at least two UV lamp containing devices as disclosed herein (for example, at least two, at least three, at least four, at least five, etc.).

Benefits of the invention disclosed herein can include, but are not limited to: point-of use drinking water treatment, eliminates pathogenic bacteria and viruses, does not need chlorine or other chemicals, allows continuous flow capability, is small and compact, and is also easy to install.

### Ultraviolet (UV) Lamps

A number of UV lamp types can be used in the current device to provide a source of ultraviolet light. In some embodiments, the UV lamp is selected from a UV LED, a UV laser, a secondary process generated UV light (e.g. photoexcited phosphors), or high/low pressure mercury lamp including cold cathode lamps (CCL).

Water treatment and reuse using instant-on/off capable UV cold cathode lamps with intensity sensors has a number of advantages over other disinfection methods, including: energy efficiency, lightness and portability, no formation of disinfection byproducts, low heat generation, and the potential for very low cost. These advantages make potential markets for UV cold cathode disinfection vast and diverse, particularly for point of use and point of entry devices and applications in developing countries.

Disinfection measurements can include, for example, (1) 4-log MS2 virus reduction the EPA standard for complete treatment of viruses in groundwater (USEPA, 2006), (2) the 40 mJ/cm² NSF 55A dose standard (NSF International, 2004), and (3) the 186 mJ/cm² EPA standard to receive complete virus inactivation log-reduction credit from UV alone in drinking water utilities (USEPA's Office of Water, Carollo Engineers, Malcolm Pirnie, The Cadmus Group, Karl G. Linden, and James P. Malley Jr. (2006) “Ultraviolet Disinfection Guidance Manual For The Final Long Term 2 Enhanced Surface Water Treatment Rule.” United States Environmental Protection Agency. Washington, D.C.).

Cold cathode lamps have been used in batch systems for UV disinfection of drinking water, but are not currently used in flow-through systems. These systems provide for disinfection of drinking water, wastewater, recycled water and other environmental media and surfaces. Application to point of use devices are especially appealing due to the energy efficiency, lightness, potential low cost, no formation of disinfection byproducts, low heat generation, and other advantages.

In the United States, waterborne disease is still a major threat to the elderly, immunocompromised, the very young, and those with gastrointestinal diseases (e.g., Crohn's disease); The CDC estimates 19.5 million cases of waterborne disease from public systems (Reynolds K A, Mena K D, Gerba C P. (2008). Rev Environ Contam Toxicol. 192:117-158) and this does not include the waterborne disease risk of the 30 million Americans relying on untreated private well water is unknown. Many communities in developing countries cannot provide safe drinking water to the home. For example, in India and China, hundreds of millions of people have gained access to piped water since 1990, but the water is typically unsafe to drink (WHO and UNICEF (2015). Progress on Sanitation and Drinking Water: 2015 Update and MDG Assessment. Geneva: World Health Organization; Kumpel, E., & Nelson, K. L. (2014). Environmental science & technology, 48 (5), 2766-2775). Of course, in many communities, piped water infrastructure is non-existent and available sources are unsafe to drink without treatment (Bain, B. J. (2015). Blood cells: a practical guide. John Wiley & Sons), Additionally, unsafe sanitation, including nearly 900 million people defecating in the open (WHO and UNICEF, 2015), can contaminate the ground and lead to the widespread occurrence of waterborne diseases. Point of use drinking water treatment provides a possible solution to these problem (Sobsey, M. D., et al. Environmental science & technology, 42 (12), 4261-4267).

Point of use UV disinfection systems have been successfully implemented in some settings (Gruber, J. S., et al. (2013). The American journal of tropical medicine and hygiene, 89 (2), 238-245; Reygadas, F., et al. (2015). Water research, 85, 74-84), However, these systems are large and impractical for faucet-based use or they are expensive with complicated plumbing installation. Cold cathode UV disinfection systems provide a compact, economical way to inactivate waterborne pathogens at the tap.

Some of the benefits of using a cold cathode lamp include: it turns on instantly, it has high-wall plug efficiency, it has a high output, and also is a long-lasting lamp. In addition, the cold cathode lamps are relatively inexpensive, can be used in a flexible configuration, and are compact.

A further method of water treatment uses UV LED (light emitting diode) light for water treatment. The use of UV LED light has the advantage of being able to use a wider UV band with multiple LED wavelengths, can offer a high-power output with less power consumption than UV lamps, UV LEDs have greater longevity, power up quickly without requiring a delay time built into the system for the UV light source to reach its optimum UV energy output, and do not contain mercury. In some embodiments, UV LEDs can be used as the UV light source. However, one current drawback of UV LEDs is that they can be expensive.

UV lamps can be, for example, low pressure, medium pressure, and or pressure UV germicidal lamps.

In some embodiment, the UV lamp or UV light source is a UV laser. In some embodiments, the UV laser is capable of providing a UV laser light energy that is significantly more powerful than a conventional UV lamp.

In some embodiments, the device can incorporate the use of multiple UV lamp technologies such as LED, laser, fluorescent, excimer, incandescent, cold cathode, hot cathode, and others.

The most common mechanism of UV disinfection is through absorbance by DNA and RNA and the formation of pyrimidine dimers that prevent organisms from replicating; absorbance of UV light by nucleic acids peaks around 254-nm (EPA's Office of Water, 2006). In some embodiments, the UV wavelength ranges from, for example, in the 100 nm to 450 nm. The measurement wavelengths can include, for example, about 100 nm, about 150 nm, about 200 nm, about 250 nm, about 300 nm, about 350 nm, about 400 nm, or about 450 nm.

In some embodiments, the device comprises a spiral-shaped UV-light source. In some embodiments, the UV light source is comprised in two spiral shapes. In some embodiments, the UV light source is comprised in at least two spiral shapes. In some embodiments, the UV light source comprises a smaller spiral UV lamp dimensioned to fit within a larger spiral UV lamp.

In some embodiments, the parameters of UV lamp can be adjusted for the size of a liquid container (for example, a water bottle). In some embodiments, based on the bottle neck entrance being 1.25″ or ˜31 mm diameter, the inner spiral has a diameter of about 13.5 mm; the outer spiral has a diameter of about 16.5 mm; the inner and outer coil are attached at the bottom; the electrical connections can be at the top, vertical, parallel, or on opposite sides so that the lamp is held evenly; and the number of spirals can be two or more. However, the devices disclosed herein are dimensioned so as to fit onto the top of a water bottle, and the size ranges for the spiral UV lamps can be adjusted by one of skill in the art to fit various sized bottles or containers. Nonlimiting examples of water bottles include Nalgene bottles and Swell bottles.

In some embodiments, the device disclosed herein is funnel shaped. In some embodiments, the device may be fitted onto a water bottle via an adaptor. In some embodiments, the device may be fitted onto a container, water bottle, thermos, canteen, or other device used as a liquid (for example, water) container. In some embodiments, the adaptor can be funnel shaped. Using various sized adaptors, the devices disclosed herein can be fitted to any number of differently shaped water bottles. In some embodiments, the device may contain threads to screw onto the threads of a thermos, bottle, or container.

As consumers become increasingly health conscientious, they are looking for new and easy methods for filtering and/or disinfecting their water. The devices and methods disclosed herein provide a convenient method for disinfecting water for any sized thermos or water bottle.

### Housing Container and Highly Reflective Cavity

The UV lamp of the device is comprised within a housing container. The housing container can also be referred to as a water flow chamber. The housing container provides protection of a consumer from the ultraviolet light rays, and also provides a highly reflective cavity to reflect the ultraviolet light rays to provide increased efficiency for the disinfection and the inactivation of pathogens in the water sample. In some embodiments, the lamp is submerged in the highly reflective cavity.

In some embodiments, the housing container is made of a metal. In some embodiments, the housing container is made of aluminum.

In some embodiments, the highly reflective cavity is provided by the housing container itself. For example, the housing container can be made of a metal, such as aluminum, which provides a highly reflective surface to reflect the UV light rays from the UV lamp.

In some embodiments, the highly reflective cavity can be provided using a highly reflective material to line the housing container.

In some embodiments, a thin protective coating can be applied, in order to help prevent oxidation of the highly reflective coating, which can occur due to the contact with the water.

### Flowing Water Samples and Methods of Use

In some embodiments, the UV device can be used to disinfect a flowing water sample. For example, the UV device could be used for disinfection in flowing water samples from a faucet or a sink, in a refrigerator, or in water fountains. In some embodiments, the devices herein can be used for disinfection of a flowing water sample into a liquid container (thermos, water bottle, and the like).

There are over 30 million private well users. Most of the water from these wells receives no treatment for disinfection. There are over 3 million faucets in homes with newborns. Newborns require contaminant free water to mix with baby formula. In addition, as consumers become more health conscientious, the present invention provides them with a suitable at-home solution for improved water quality and disinfection.

In one aspect, provided herein is a method for inactivating a pathogen in a flowing water sample, comprising:
subjecting a flowing water sample to a device, the device comprising:
   a housing container, wherein the housing container comprises a highly reflective cavity;
   an ultraviolet lamp, wherein the ultraviolet lamp is comprised within the housing container;
   an entry point and exit point for a flowing water sample, wherein the flowing water sample is in direct contact or in close contact with the ultraviolet lamp; and
wherein the ultraviolet lamp delivers ultraviolet light rays both radially inward and outward for inactivating a pathogen.

In one embodiment, the device further comprises a flow sensor, wherein the flow sensor indicates the amount of an ultraviolet light dose provided to the flowing water sample. In one embodiment, the device further comprises a highly reflective material lining the housing container. In one embodiment, the device further comprises a protective coating over the highly reflective material.

In one embodiment, the ultraviolet lamp is a low pressure, medium pressure, or high-pressure mercury lamp. In one embodiment, the ultraviolet lamp is a cold cathode lamp. In one embodiment, the ultraviolet lamp is a UV LED. In one embodiment, the ultraviolet lamp is a UV laser light source.

In one embodiment, the method kills greater than 99% of a pathogen in the flowing water sample. In one embodiment, the method kills greater than 99.9% of a pathogen in the flowing water sample. In one embodiment, the method kills greater than 99.99% of a pathogen in the flowing water sample.

### Flow Sensor

In some embodiments, the device comprises a flow sensor. This flow sensor can be useful, for example, for in-home use conditions, to enable the user to identify when the UV light is working. In some embodiments, the flow sensor can also provide for the amount of UV light administered to the water sample. For example, the amount could be shown by a digital display or based on a dial representing the amount of UV light administered. In addition, a UV intensity sensor that can be used to monitor and control lamp output and that are compatible with an inexpensive, faucet-based commercial unit are also disclosed herein.

In one embodiment, the flow sensor is a digital representation. In one embodiment, the flow sensor is an LCD display. In one embodiment, the flow sensor is a dial. In one embodiment, the flow sensor is an LED (light emitting diode) bar indicator. In one embodiment, the flow sensor is a visible light.

### Pathogens

Various infectious agents are associated with human waterborne diseases, including for example, Campylobacter, E. coli, Leptospira, Pasteurella, Salmonella, Shigella, Vibrio, Yersinia, Proteus, Giardia, Entoamoeba, Cryptosporidium, hepatitis A virus, Norwalk, parvovirus, polio virus, and rotavirus. The most common bacterial diarrheal diseases on a worldwide basis are associated with waterborne transmission of Shigella, Salmonella, pathogenic E. coli, Campylobacter jejuni, and Vibrio cholera.

The UV devices and methods disclosed herein can be used against any of the above pathogens, or any other pathogens of interest that are susceptible to disinfection by UV light.

In one testing example, the viral surrogate MS2 is used as an indicator of UV efficacy; it is the most UV-resistant known virus surrogate (Hijnen, W. A. M., et al. (2006). Water research, 40 (1), 3-22). The MS2 virus is widely preferred as an indicator of UV treatment effectiveness because E. coli and all other known vegetative bacteria are much more sensitive to UV than MS2 virus; likewise, with the common protozoan parasitic pathogens Cryptosporidium and Giardia. Many harmful pathogens, such as the ones above, can enter drinking water distribution pipes and travel untreated to household faucets by way of infiltration from leaks or breakages in the water system. In some embodiments, the MS2 reductions are seen at different flowrates (for example, 2 L/min, 5 L/min and 10 L/min).

### EXAMPLES

The following examples are set forth below to illustrate the devices, methods, and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

### Example 1

### Pathogen-Inactivating Ultraviolet (UV) Device

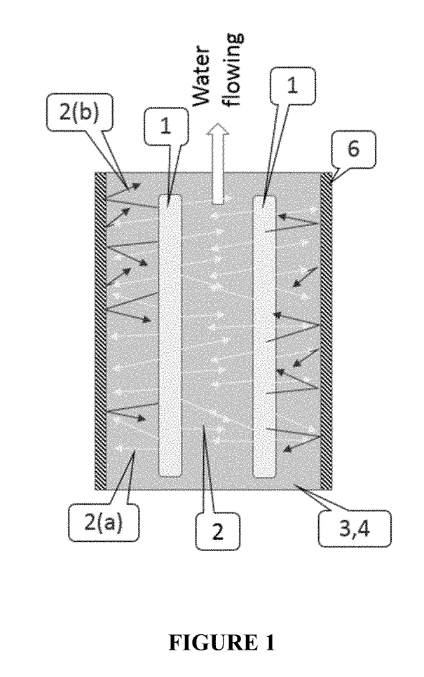

In this example, a pathogen-inactivating UV device is disclosed according to the schematic shown in FIG. 1. In the embodiment according to this example, the device is comprised of:

1) An ultraviolet light source;

2) The useful ultraviolet light is delivered radially both inward and outward. This allows the outward rays 2(a) to already participate in water disinfection even before they are reflected by the aluminum surface. These outward rays are then reflected back (2(b)) and participate again in water disinfection on their way inward;

3) This method is in such a manner that the light source is submerged in flowing water;

4) There is no need for a fused quartz tube, because the water is in direct or very close proximity to lamp;

5) This set up minimizes optical losses and allows higher flow rates while maintaining sufficient dose (optical power density*exposure time) of UV rays for effective disinfection;

6) The highly reflective cavity (for example, the aluminum tube) forms the wall of the housing container (also referred to as the “water flow chamber”).

### Example 2

### Microbiological Methods

Preparation of challenge organism stocks and enumeration of all samples are based on established and documented practices. For virus challenges, EPA Method 1602, Male-specific (F+) and Somatic Coliphage in Water by Single Agar Layer (SAL) Procedure (USEPA, 2001) are used. Appropriate control samples are used in each experiment and are shielded from ambient light. Complete mixing of original samples and dilutions are ensured through vortexing. All samples are exposed to UV light by one team for consistency, with microbiological analysis conducted and reported by two teams whenever possible. Five aliquots of each virus sample are collected, with two for immediate analysis and three frozen at −80°C. for subsequent analysis if an assay fails or a result requires confirmation.

Other microorganisms are also tested with the UV devices. E. coli bacteria were tested in a flow-through experiment, but the E. coli are too sensitive. In the first challenge experiment, over 7-log₁₀ (99.99999%) were killed during an exposure of less than 0.2 seconds. E. coli and all other known vegetative bacteria are much more sensitive to UV than MS2; likewise with the common protozoan parasitic pathogens Cryptosporidium and Giardia. Viruses are the major challenge for UV disinfection. Therefore, the most robust surrogate for pathogenic viruses (MS2) (Hijnen, W. A. M., et al. (2006). Water research, 40(1), 3-22) can be used in all exposure experiments.

### Example 3

### Exposure Testing Apparatus

Proper measurement techniques for the UV irradiation characteristics are necessary. These were carried out using established methods, including using NIST traceable power meter coupled to a UV-enhanced photodiode, a spectrograph coupled to a UV-enhanced CCD and UV holographic grating for precise measurement of emission source spectra. Uniformity of exposure is determined by using a UV optical fiber coupled to either the photodiode/power meter or the spectrograph and mapping the desired area

Finally, parameters such as optical power loss at any additional optics components used (e.g. UV aluminum mirrors), optical reflection at the water surface, sample depth and thus absorption through the body of liquid, are accounted for in order to establish the exact dose received by the sample.

To enhance the UV dose available for inactivation, the lamps can be encapsulated in a highly reflective cavity (for example, aluminum), which—unlike glass mirrors—has high reflectivity in the germicidal UV range and prevents the useful UV light from being lost.

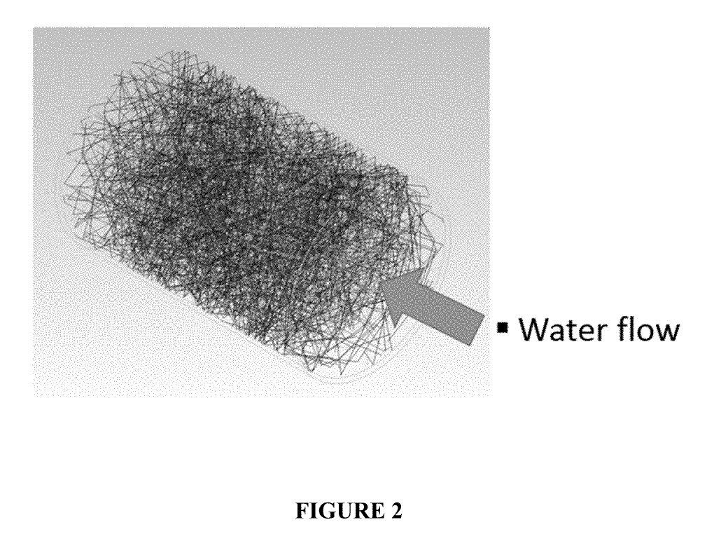

To further enhance the UV disinfection, additional changes were made to allow a higher flow rate by optimizing the UV exposure. In this example, the water is brought in closer contact with the UV light. Such a design is guided by 3D optical simulations (FIG. 2) that have been developed. Data have revealed that the diameter of the water reactor can be increased, which concurrently increases the total flow rate by 2× to 3× without sacrificing exposure dose. FIG. 2 is an illustration of the type of 3D simulations of a UV lamp water reactor. This device is more transportable and features a “plug-and-flow” capability allowing for simple point of use installation.

### Example 4

### Viral Indicators of UV Effectiveness

In this example, the viral surrogate MS2 is used as an indicator of UV effectiveness; it is the most UV-resistant known virus surrogate (Hijnen, W. A. M., et al. (2006). Water research, 40 (1), 3-22). MS2 is an icosahedral, positive-sense single-stranded RNA bacteriophage (a virus that infects bacteria) that is widely preferred as an indicator of UV treatment effectiveness because its low susceptibility to UV is similar to that of adenoviruses (the human pathogenic viruses most resistant to UV) (Hijnen, W. A. M., et al. (2006). Water research, 40(1), 3-22). As noted above, the lamp kills bacteria too quickly to make E. coli or other challenge bacteria experimentally useful, under the present conditions.

In this example, the inactivation rates of MS2 viral indicators are determined in drinking water using a UV lamp with a flow rate of 5 L/min. The dose required to achieve the EPA standard of 4 log10 reduction (99.99%) of MS2 virus is then determined. For the viral challenge, the test organism is a strain of the MS2 virus.

Samples are collected using sterile autoclavable bottles. Five aliquots of each virus sample are collected, with two for immediate analysis and three frozen at −80°C. for subsequent analysis if an assay fails or a result requires confirmation. Microbial concentrations in the water are evaluated before and after exposure to UV and log10 reductions calculated; the MS2 are evaluated using EPA Method 1602 (EPA, 2001).

In another example, a UV dose of 40 mJ/cm² (based on the known inactivation-to-dose relationship of MS2 virus; see Hijnen, W. A. M., et al. (2006). Water research, 40(1), 3-22) is used in drinking water using a counter-top fixed UV lamp with a flow rate of 10 L/min. 40 mJ/cm² is the standard NSF 55A dose for UV devices, the most rigorous UV standard from NSF International (NSF International, 2004). The above flow rate and dose can achieve the EPA standard of 4 log₁₀ reduction (99.99%). Challenge tests are conducted as described above.

In another example, a 2 L/min flow is achieved and a dose of 186 mJ/cm² (based on the known inactivation-to-dose relationship of MS2 virus; see Hijnen, W. A. M., et al. (2006). Water research, 40(1), 3-22). 186 mJ/cm² is the required dose for centralized water treatment facilities to receive full virus reduction credit solely through UV (USEPA et al., 2006). The testing protocol is identical as described above, except for the flow rate.

In another example, the reactor is modified based on the 3D optical modeling. This example includes integrating a few keys degrees of user-autonomy to the UV lamp setup by implementing electronic means to monitor and report in real-time the optical output of the lamp, and therefore be able to switch off the water flow if the UV source is no longer efficient for inactivation.

To measure the amount of UV light emitted by the lamp in the water reactor, an ultraviolet sensitive photodiode is used that provides the ability to quantify the amount of UV light emitted. The UV sensor (or flow sensor) is fixed in the water reactor and hermetically sealed. The electronic circuitry drives the sensor, amplifies the output electrical signal, and calibrates it so that the actual optical output of the lamp can be displayed on a small 4-digit liquid-crystal display (LCD) display (or a simpler demonstration could be using a small light emitting diode (LED) bar indicator). Not only would this let a user have a real-time measurement of the output power of the lamp, it enables two longer-term benefits: if the lamp output is below threshold, the system could be able to stop the flow of water by using an electronically-actuated valve; additionally, the user would be able to have a more quantitative measure of water transparency.

MS2 reductions under three flowrates (2, 5 and 10 L/min) are examined, with at least three replicate experiments. The consistency of results is evaluated as measured by less than 20% variation in log reductions across three replicates at each flow rate.

Long-term outcomes are focused on impacting health and well-being by protecting consumers from pathogens in drinking water.

This UV lamp embodies the three principles of sustainability, i.e. environmental, social, and economic criteria. First, the development of UV disinfection system will benefit the environment through the improvement of water quality and energy efficiency. UV lamps will greatly increase the water quality by decreasing the amount of pathogens in the water. In addition, the UV lamp (for example, the cold cathode lamp) can lead to reduced carbon emissions through greater energy efficiency.

Then, the development of UV disinfection system is beneficial for people by protecting them from waterborne disease. Moreover, UV disinfection systems eliminate the use of chemicals and the production of carcinogenic by-product. Thanks to the flexibility of the system, this UV device can be used anywhere in the world, including in developing countries.

The use of UV lamps for the disinfection of wastewater presents many advantages such as lightness and portability, no formation of disinfection byproducts, low heat generation, and the potential for very low cost. These advantages make potential markets for UV treatment disinfection system vast and diverse. Moreover, the use of UV treatment would decrease the cost linked to waterborne diseases treatment while greatly improving the water quality.

### Example 5

### Spiral UV Lamps

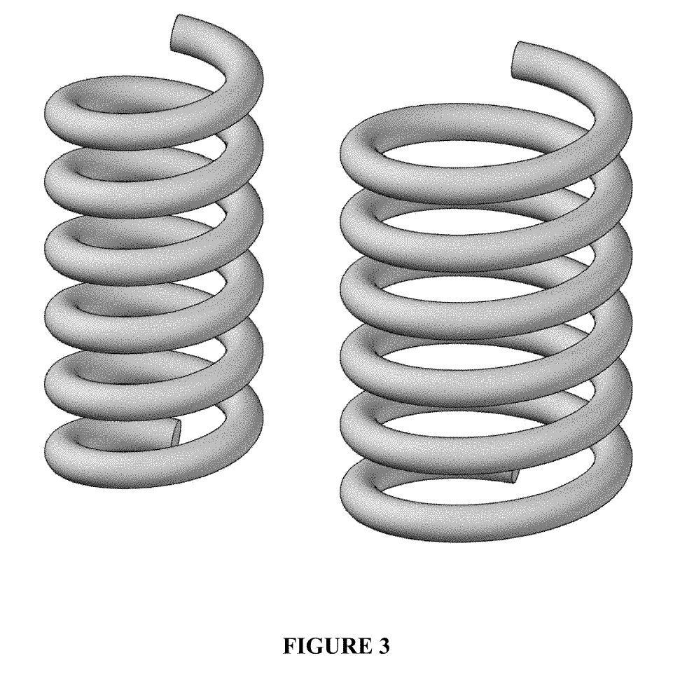

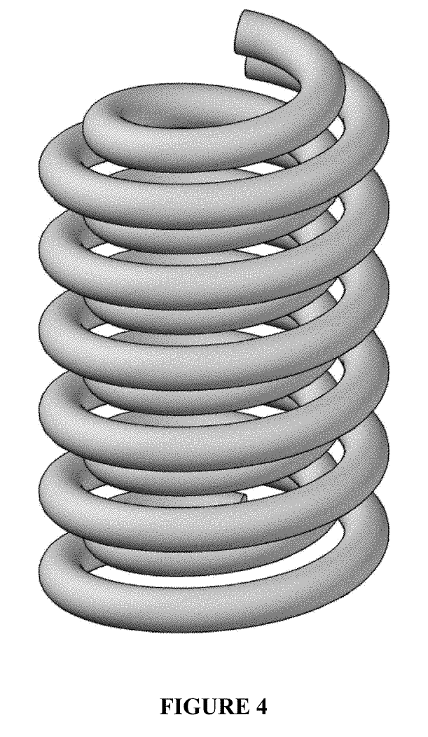

FIGS. 3 and 4 show an example of a spiral-shaped UV-lamp (UV light source) for the disinfection of a flowing water sample. In FIG. 3, the UV lamp is shown split into two, where the smaller spiral is dimensioned so as to fit into the larger spiral. FIG. 4 shows an example of a spiral UV-lamp device for the disinfection of a flowing water sample, where the smaller spiral is shown to fit into the larger spiral. The parameters of the present example are shown below (based on a bottle neck entrance being about 1.25″ or ˜31 mm diameter):

inner spiral diameter=13.5 mm;
outer spiral diameter=16.5 mm;
inner and outer coil are attached at the bottom;
electrical connections are at the top, vertical, parallel, or on opposite sides so that the lamp is held evenly;
number of spirals=can be two or more

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

We claim:

1. A device for inactivation of a pathogen in a flowing water sample, the device comprising:
a housing container, wherein the housing container comprises a highly reflective cavity;
an ultraviolet lamp, wherein the ultraviolet lamp is comprised within the housing container;
an entry point and exit point for a flowing water sample, wherein the flowing water sample is in direct contact or in close contact with the ultraviolet lamp; and
wherein the ultraviolet lamp delivers ultraviolet light rays both radially inward and outward.

2. The device of claim 1, further comprising a flow sensor, wherein the flow sensor indicates the amount of an ultraviolet light dose provided to the flowing water sample.

3. The device of claim 1, further comprising a highly reflective material lining the housing container.

4. The device of claim 3, further comprising a protective coating over the highly reflective material.

5. The device of claim 1, wherein the ultraviolet lamp is a low pressure, medium pressure, or high-pressure mercury lamp.

6. The device of claim 1, wherein the ultraviolet lamp is a cold cathode lamp.

7. The device of claim 1, wherein the ultraviolet lamp is an ultraviolet light emitting diode (LED).

8. The device of claim 1, wherein the ultraviolet lamp is an ultraviolet laser light source.

9. The device of claim 2, wherein the flow sensor is a digital representation.

10. The device of claim 2, wherein the flow sensor is a liquid-crystal display (LCD).

11. The device of claim 2, wherein the flow sensor is a light emitting diode (LED) bar indicator.

12. A method for inactivating a pathogen in a flowing water sample, comprising:
subjecting a flowing water sample to a device, the device comprising:
a housing container, wherein the housing container comprises a highly reflective cavity;
an ultraviolet lamp, wherein the ultraviolet lamp is comprised within the housing container;
an entry point and exit point for a flowing water sample, wherein the flowing water sample is in direct contact or in close contact with the ultraviolet lamp; and
wherein the ultraviolet lamp delivers ultraviolet light rays both radially inward and outward for inactivating a pathogen.

13. The method of claim 12, wherein the device further comprising a flow sensor, wherein the flow sensor indicates the amount of an ultraviolet light dose provided to the flowing water sample.

14. The method of claim 12, wherein the device further comprising a highly reflective material lining the housing container.

15. The method of claim 14, wherein the device further comprising a protective coating over the highly reflective material.

16. The method of claim 12, wherein the ultraviolet lamp is a low pressure, medium pressure, or high-pressure mercury lamp.

17. The method of claim 12, wherein the ultraviolet lamp is a cold cathode lamp.

18. The method of claim 12, wherein the ultraviolet lamp is an ultraviolet light emitting diode (LED).

19. The method of claim 12, wherein the ultraviolet lamp is an ultraviolet laser light source.

20. The method of claim 12, wherein the method kills greater than 99% of pathogens in the flowing water sample.
